(19) United States
(12) Patent Application Publication
(10) Pub. No.: US 2005/0067302 A1
(43) Pub. Date: Mar. 31, 2005

(54) Electrochemical sensing of lubricant condition

(75) Inventors: Martin W. Kendig, Thousand Oaks, CA (US); Frederick M. Discenzo, Cleveland, OH (US)

Correspondence Address: KOPPEL, JACOBS, PATRICK & HEYBL, 555 ST. CHARLES DRIVE, SUITE 107, THOUSAND OAKS, CA, 91360, US

(73) Assignee: INNOVATIVE TECHNOLOGY LICENSING LLC

(21) Appl. No.: 10/675,699

(22) Filed: Sep. 29, 2003

(51) Int. Cl. G01N 27/26

(52) U.S. Cl. 205/775; 204/422; 204/412

(57) ABSTRACT

A sensor, and method of using the sensor, for determining changes in the chemical or electrolytic properties of non-electrolyte, or weakly electrolytic fluids comprising an anode, cathode and reference electrode covered by a solid electrolyte film. Changes in these properties are indicative of degradation of the fluid or dissolution therein of conductive materials from the surfaces in contact with that fluid.

### BACKGROUND

Virtually all rotating machinery require lubricating fluids. Motors, of which there are over 34 million industrial (non-consumer/non-appliance) units in the US are one example of these rotating machines. A major cause of failure of these rotating equipment is bearing wear and seal failure. Bearing and seal damage is typically due to lubricant contamination, chemical degradation, loss of lubricant, or incorrect lube. An ability to monitor the quality of a lubricant would provide an early indication of the likelihood of bearing or seal failure and could permit early detection of unacceptable changes in lubricant effectiveness—in many cases before mechanical damage has occurred. Existing lubricating fluid monitoring devices are not amenable to continuous, online monitoring. Additionally, they are costly (e.g. optical spectroscopy device being developed by Foster-Miller Technologies will cost >$5K and is considered a breakthrough). They monitor only a specific parameter (e.g. dielectric, temperature, pH, particle count, or clarity), and generally require that a sample of lubricant be periodically extracted and analyzed “off-line” such as at an outside testing lab or with in-house hand-held or laboratory test equipment (e.g. Entek viscometer, or laboratory FTIR analyzer).

Lubricants, particularly hydrocarbon based lubricants are non-electrolytic or weak-electrolytic and therefore are not amenable to electroanalysis. However, the presence of, and changes in, electroactive species present in lubricants, hydraulic fluids, cutting oils, cooking oils, and fuels, which relate directly to the fluids chemical composition or decomposition, can be monitored as a means to determine a change in lubricant performance, or other physical quality of the fluid. The electro-activity of these species reflects the presence of contaminants or the effective levels of additives, and ultimately the remaining useful life of the lubricant. Representative examples of such electroactive species are absorbed water, decomposition, oxidation or reduction byproducts, pH modifying constituents, antioxidants, stabilizers, etc. Electrochemical analysis to measure the presence of these species would provide a valuable source of information related to lubricant chemistry and provide an indication of changing operating characteristics. A number of electroanalytical procedures have been explored for evaluating these characteristics in an attempt to provide a correlation to the remaining useful life of lubricant.” In particular, voltammetric waves have been evaluated regarding the oxidation and reduction of anti-oxidation additives in lubricants such as Zn dialkyldithiophosphates. Other electro-active species from lubricant, oil or hydrocarbon fluid breakdown may result in acids, oxidation products or peroxides which can also be detected voltammetrically. Kaufman (U.S. Pat. No. 5,071,527) claims that the voltammetric methods can be used in situ using bare electrodes by applying cycling electrical voltages to the lubricant stream and monitoring the resulting current at a second electrode. Very large voltages are required and iR drop precludes a realistic knowledge of the true electrode potentials. The more practical concepts described by Kaufman require the addition of solvent and electrolyte to the lubricant sample before the cyclic voltametric analysis can be performed, thus rendering the technique not applicable for continuous on-line monitoring.

Some of the problems in doing electrochemical analysis in non-electrolytic or weak-electrolytic (e.g. non-conducting) fluids, such as lubricants, are addressed if the electrodes used for electrochemical analysis are surrounded by an electrolyte into which the active species from the fluid to be analyzed will partition. Fang, U.S. Pat. No. 5,518,590, shows an electrochemical sensor for monitoring motor oil deterioration which utilizes an electrochemical cell comprising a working electrode, a counter electrode and a reference electrode surrounded by a liquid or gel-like inter phase, with that inter phase separated from the oil by a hydrophilic membrane, such as nylon 66.

Another approach is the use of a planar microelectronic device such as shown in FIG. 5 related in some respects to U.S. Pat. Nos. 6,286,363, 6,196,057 and 6,023,961 incorporated herein by reference and issued to one of the applicants herein. These patents show an electrode for monitoring characteristics of lubricants including a chemical sensor of a 3-electrode configuration comprising an anode, cathode and a reference electrode. An electrolyte film is not suggested. This device can sense resistance and capacitance of a lubricant, but ohmic drop precludes its ability to sense electroactive species. Farrington and Slater (Analyst, 122, p93-596 (1997)) and Clough (Analytica Chimica Acta, 315, p15-26 (1995)) have also attempted to monitor lubricant electro-activity. Farrington and Slater addressed the problem of fluid resistance by using micron-sized electrodes. However, there is considerable signal to noise and fouling problems associated with the Farrington and Slater approach. Clough's uses a conducting polymer (Nafion) film covered by a water absorbing film of cellulose triacetate (CTA) to measure water concentrations in polyol ester (POE) lubricants. POE lubricants are known to readily absorb moisture and therefore can be characterized as much more electrically conductive then oil-based lubricants, which are considered to be non-electrolytes or, at best, very weak electrolytes. Clough indicates that the CTA covering in her sensor is a necessary element to provide a hydrophilic barrier so that certain organic materials in the lubricant are prevented from permeating into the Nafion film and, as a result, interfering with absorption and subsequent analysis of the water content. In addition, the sensor described by Clough has no reference electrode. Hence, the true relation of current and voltage can not be determined with the precision needed to allow diagnosis.

Accordingly, there is a need for an economical, effective monitoring method for determining the quality, performance and operating life of non-electrolytic or weakly electrolytic lubricating fluids, particularly hydrocarbon based lubricants.

### BRIEF DISCUSSION

Direct on-line, continuous diagnosis of fluid quality and projected performance in a non-electrolyte or weak-electrolyte fluid by the monitoring of electroactive species, particularly a hydrocarbon-based lubricant, is addressed by the devices described herein and incorporating features of the invention. Applicant has found that non-electrolyte or weak-electrolyte fluids can be electroanalyzed by using an active electrodes system which is enclosed in a coating of a conducting solid-state electrolyte, such as a perfluorosulfonate ionomer film, for example Nafion™.

While devices incorporating features of this invention have some similarities to devices described in patents by Kaufinan (U.S. Pat. No. 4,744,870, U.S. Pat. No. 4,764,258, U.S. Pat. No. 5,071,527) and the published work of Clough and of Farrington and Slater, the subject invention addresses several deficiencies with these prior approaches to the problem and incorporates considerable improvements. Kaufman addressed the problems associated with fluid resistance by sampling the lubricant and dissolving the lubricant fluid in an electrolyte. Farrington and Slater addressed this problem by using micron-sized electrodes. Neither of these solutions are particularly conducive to the monitoring of lubricants in that Kaufman's approach rules out in-situ analysis and there are considerable signal to noise and fouling problems associated with the Farrington and Slater approach. Clough's approach relates to the use of a conducting polymer (Nafion) film. However, the sensor described by Clough requires a hydrophilic, water wetable barrier over the Nafion film to prevent blocking of the Nafion film. Further, Clough has no reference electrode. Hence, the true relation of current and voltage cannot be determined with the precision needed to allow diagnosis.

A sensor incorporating features of the invention comprises a simple 3-electrode, electro-chemical sensor with a solid electrolyte film coating used to monitor electrical changes in nonelectrolytic lubricants. Addition benefits of devices incorporating features of the invention include:
1. An array of identical sensor elements having a solid film of an electrolyte coating may be used to improve the signal-to-noise ratio
2. An array of identical sensor elements with varying electrolyte film thickness improves the sensitivity (provides a measure of transport time) and improves the dynamic response of the sensors
3. Electrolyte films other than Naflon, such as solgel films, solid—polymer electrolytes such as Li salt-doped PEO, polyelectrolyte gels, and other solid polymer electrolytes such as described in “Solid Polymer Electrolytes” by F. Gray Wiley—VCH, 1991 ISBV 0-471-18737-2 may be employed or Nafion may be modified with certain reagents. Some of these may be more sensitive or selectively sensitive to specific chemical species in the lubricant. An array of sensors with various electrolyte coatings significantly enhances sensor accuracy. Input from each sensor of the array can be input to a neural network and trained to diagnose the lubricant.
4. The electrolyte film also serves to protect the sensing elements, particularly in flowing lubricants.
5. The ability of the electrolyte film to entrain lubricant helps insure the reversibility of the redox reaction by performing the symmetric reaction on localized, non-flowing fluid.
6. The electrolyte film may further enhance the electrochemical reaction by reducing the possibility of intervening chemical reactions during the electrochemical process.
7. By employing a sinusoidal voltage to the sensor and sweeping a range of frequencies the phase and gain of the response signal can be determined. This will provide valuable information related to the electrolyte thickness, fluid transport and other fluid rheological properties.
8. By employing a sinusoidal voltage and performing a Fourier Transform (FFT) [on the current response a harmonic spectra can be obtained. The individual harmonics can be fed into a neural network and trained to diagnose the lubricant.
9. An electrochemical reaction can be performed on the fluid using fast cyclic voltammetry (FCV) to obtain improved sensor response.
10. A dual-sensor configuration can be used with the same electrolyte coating where each sensor is performing CV but is operated 180 degrees out of phase with the adjacent sensor. That is, one sensor is reducing while the other is oxidizing. This can provide unique information regarding the electrolyte performance, chemical species changes, improved sensor accuracy, and transport phenomena of the fluid. The frequency of voltage excursions may sweep a range of frequencies.
11. A dual-sensor configuration can be used in which one cell will contain no electrolyte, and therefore only sense the resistance and dielectric constant of the lubricant, while a second sensor contains an electrolyte rendering it sensitive to the electroactive oxidation-reduction species in the lubricant.

### DESCRIPTION OF DRAWINGS

FIG. 1 shows cyclic voltammograms of the sensor response for dry oil (Mobil 424) and Mobil 424 with 2500 and 10000 ppm of water.

FIG. 2 shows Current transients observed before and after the addition of 0.5% water to a Chevron lubricant.

FIG. 3 shows the peak to peak sensor current response as a function of total water concentration in the lubricant and a calculated response based on the water-activity model (WAM).

FIG. 4 shows the calculated peak-to-peak response as a function of water concentration showing the effect of increasing the stability of S . . . (H₂O) in reaction (1) (increasing K).

FIG. 5 is a schematic representation of a microprocessor sensor assembly used for monitoring.

FIG. 6 shows a cyclic voltammogram of dry, as received Chevron lubricant. Slope relates to resistance and the separation between the positive going and negative going curves relate to the capacitance. This response to the saw tooth applied potential is essentially linear.

FIG. 7 is a cyclic voltammogram of as received Chevron lubricant containing 0.5% dispersed water. In this case non-linear Faradaic currents due to oxidation and reduction of water are observed. Note that the currents are nearly two orders of magnitude higher here for the wet lube as compared to the dry lube.

FIG. 8 shows a cyclic voltammogram of a lubricant with an electroactive species in addition to 0.5% water.

### DETAILED DISCUSSION

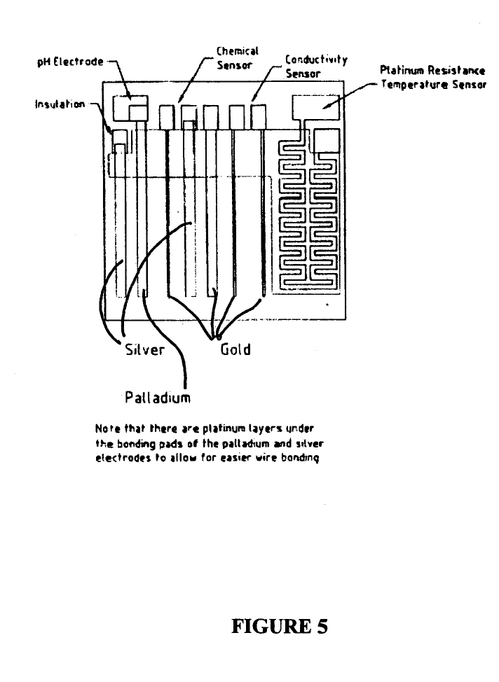

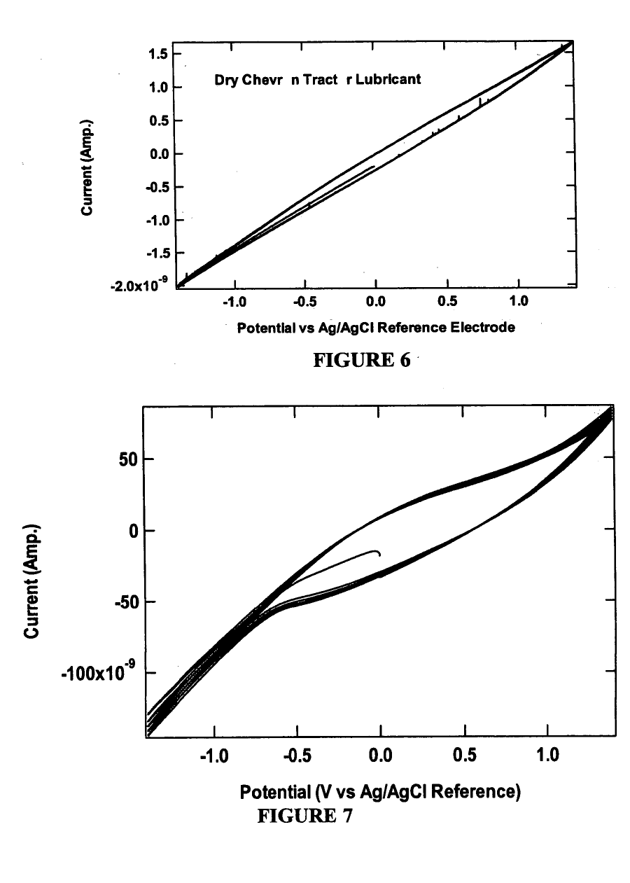

It has been discovered that the difficulties in doing electrochemical analysis in non-electrolytic or weak-electrolytic (e.g. non-conducting) fluids such as hydrocarbon based lubricants can be overcome if the electrodes used for electrochemical analysis are embedded in a solid electrolyte which will partition the active species from the fluid to be analyzed. A planar microelectronic sensor developed by Rockwell Automations is shown in FIG. 5. This device can sense resistance and capacitance of a lubricant, but ohmic drop precludes its ability to sense electroactive species. It has been discovered that this limiting condition can be overcome by coating the active electrodes with a conducting solid-state electrolyte such as Nafion. As an example, the Rockwell sensor shown in FIG. 5 was brush coated with a solution of Nafion (Aldrich 27,470-4, CAS 66796-30-3). Multiple coats (8 to 12) of Nafion solution were applied with prolonged (about 1 to about 24 hours) drying between coats. The resulting sensor was “burned-in” by cycling with an applied potential between −1.4 V and +1.4 V vs. the reference for extensive periods of time (about 1 to about 6 hours) in a Chevron lubricant and in laboratory air. After a period of about 5 min, the sensor exhibited the current detected versus applied potential as shown in FIG. 6. The sensor was then exposed to lubricant with varying quantities of water. For calibration purposes, a solution of 1%ᵥ (by volume) water in fresh Mobil 424 lubricant was made by ultrasonically dispersing the water in the lubricant. The resulting mixture was cooled and then systematically diluted with fresh Mobil 424 lubricant to form mixtures of 2 ppm, 10 ppm, 156 ppm, 620 ppm,
2500 ppm and 10000 ppm water. In all cases the sensor current response measured at the cathode was monitored as a function of cyclic voltammetric excitation. FIG. 7 slows the results for a 0.5% water solution.

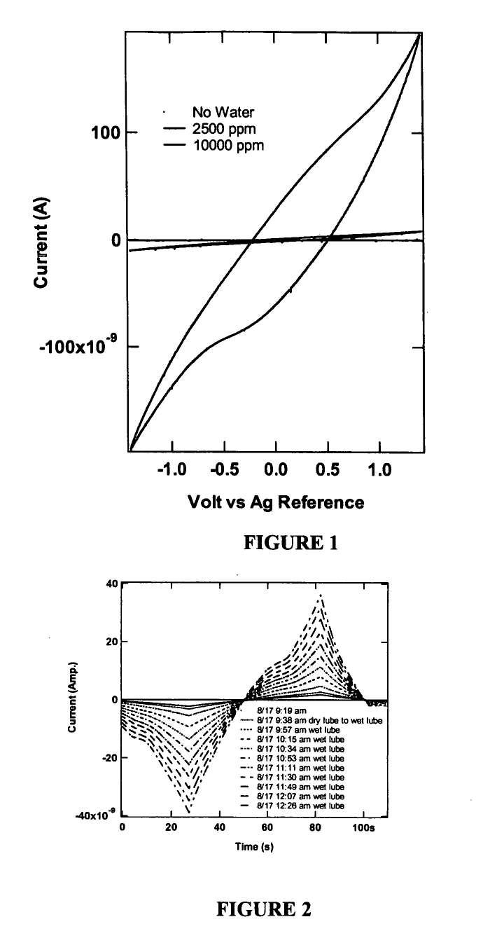

FIG. 1 shows typical cyclic voltammograms expressed as a current generated vs. applied potential. When no water is present in the lubricant, the magnitude of the currents are very low remaining at or below 2 nA. With the addition of 2500 ppm of water, a detectable current above the baseline appears. 10000 ppm water provides currents on the order of several tenths of a microamp. Furthermore, the presence of water enhances the non-linearity of the current/voltage curve, as expected, since the current response results from a Faradaic electrochemical process (oxidation and reduction of an electroactive species such as water). Faradic responses contain exponential current vs. voltage functionality as opposed to the linear current vs. voltage of a holmic response.

For example, the sensor shows a potential (˜−0.65V, in FIG. 7) where the catholic reaction accelerates. Assuming that the catholic current is a reduction of protons, then the potential of the break-point will relate to the pH of the fluid, while the maximum current relates to the total hydrogen ion present as water. Clough's approach will not have such diagnostic flexibility. Other more subtle current vs voltage features that are resolvable by use of the disclosed electrode assembly provide additional diagnostics. For example, monitoring the modification of oxidizable anti-oxidant present in the lubricant. In addition various reagents or selective phase transfer catalysts can be added to the solid electrolyte to render the electrochemical analysis selective to certain species.

The response of the sensor is not instantaneous, but requires several hours for equilibration. FIG. 2 illustrates this by a presentation of repeated current vs. time transients taken every 19 minutes for about a three (3) hour period on a lubricant with about 0.5% water. As can be seen, with the addition of water, the current response gradually increases and becomes more non-linear with time.

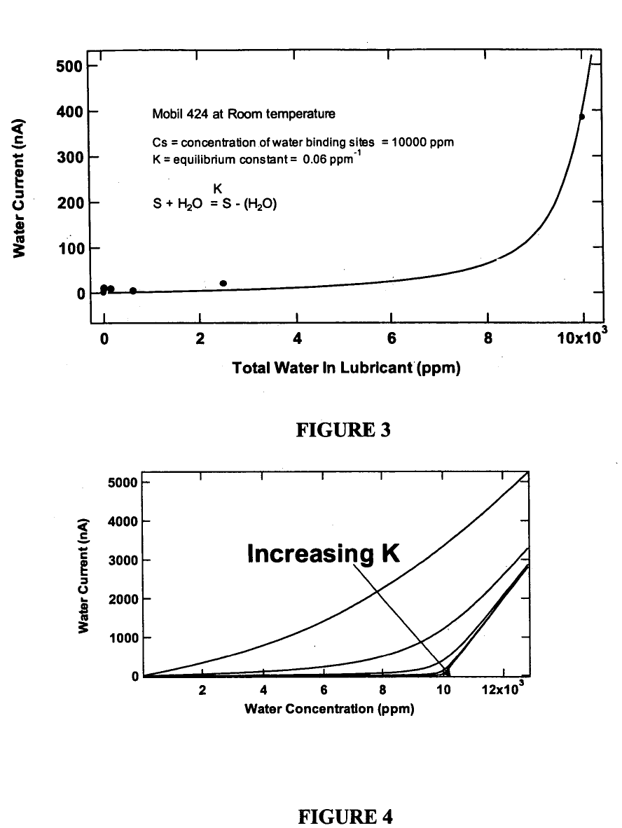

The peak-to-peak currents observed as a function of water concentration in the Mobil 424 oil appear in FIG. 3. As can be seen, the current response to the addition of water is highly non-linear. This behavior most likely results from the fact that the sensor senses electrolyte species (i.e. water) activity rather than electrolyte species (water) concentration.

In the case of water being present, and the activity is likely governed by a ‘detergency’ of the lubricant that gives the lubricant an ability to complex or deactivate the water. A simple model for this effect assumes a concentration of sites, S, in the lubricant that complex the water according to the following reaction:
S+H₂O_{free}→S . . . (H₂O) (1)

This reaction is actually in equilibrium with an equilibrium constant K,
K=[S . . . (H₂O)]/([S][H₂O_{free}])

Assuming a total concentration C_{S} of the water-binding sites S, and a total water concentration C_{W}, the concentration of H₂O_{free}, or water activity, can be calculated as
[H₂O_{free}]=−½(C_{S}−C_{W}+1/K)+½((C_{S}−C_{W}+1/K)²+4C_{W}/K)^{1/2}

It is assumed that the water activity is proportional to the sensor peak-to-peak current. FIG. 3 shows the water current vs. the water concentration and a calculated curve based on an apparent 10000 ppm for the [S] and an equilibrium constant K equal to 0.06 ppm⁻¹. The fit suggests consistency with this model.

An important outcome of the model can be seen in FIG. 4, which illustrates that water activity (free water) depends on the total water concentration when the equilibrium constant, K varies. As K decreases, that is as the stability of the lubricant binding of water (reaction 1) decreases, the signal increases for the lower water concentrations. The fact that sensor measures [H₂O_{free}] and not water concentration. [H₂O_{free}] is much more relevant to lubricant condition since [H₂O_{free}] most likely determines the extent of hydrogen embrittlement of hard bearing steel:
H₂O_{free}+Fe→FeO+2H_{ads} (4)
where the adsorbed hydrogen leads to embrittlement. If the strength of water binding by the lubricant decreased, the sensor would sense an increase in water activity. This would not be the case for a total water concentration sensor. This is a major advantage of this type of sensor.

The above example using small quantities of water is merely representative of analytic techniques which can be applied to such liquids. The electroactive nature of the non-electrolytic or weak-electrolytic fluids, such as hydrocarbon lubricants, is not limited to electrically detecting the activity of water or H⁺ and OH⁻ ions. In a like manner, the electrical activity of various different charged, electrically dissociateable or ionizable species can be monitored, such as organic complexes of heavy metal ions such as Fe(II), Zn (II), Cu (II), and Pb (II) as a means of determining lubricant status.

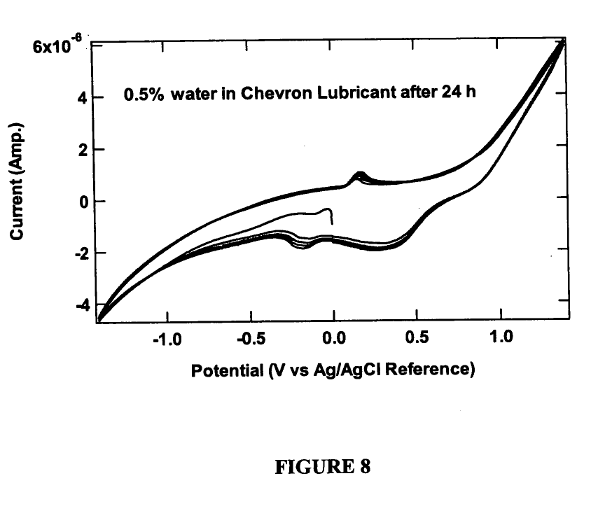

The electrochemical sensor can diagnose or track degradation mechanisms of the lubricant. For example, certain lubricants exhibit features in the cyclic voltammogram that may be related to the presence of active species in addition to or instead of water. These can be correlated with degradation of the lubricant, changes in its lubricating capabilities, and the generation of active and reactive species which can chemically attack components of the lubricated system, such as bearings and seals. This is demonstrated by the example of the wet Chevron lubricant shown in FIG. 8. An anodic maximum and two catholic minima are evident at intermediate potentials. These occur in addition to the currents due to the presence of water. These features relate to an unidentified electroactive species in the lubricant. When compared to the voltammogram of the lubricant when first added to the machine being monitored, the existence of these anomalies, and changes therein over time, can be used to identify and can be correlated with changes in the performance of the lubricant and used to establish criteria for determining the effective life of the lubricant.

In summary, it has been discovered that
The electrochemical sensor coated with the ion conducting film, such as Nafion, senses electroactivity and changes in the electroactivity of non-electrolytic or weak-electrolytic fluids such as hydrocarbon based lubricants.
The sensor can monitor the concentration and activity of water in bound and unbound states in the fluid. These states are in dynamic equilibrium.
Unbound water, as measured by the sensor, is responsible for bearing degradation through hydrogen embrittlement. Acids and active ions can be a major cause of seal degradation.
A Nafion coated sensor was found to address limitations demonstrated by prior sensors intended to monitor oil quality and stability.

1. A method of correlating changes in the chemical and physical properties of non-electrolytic or weakly electrolytic fluids comprising monitoring the electrical response of said fluid over a period of time to an electrical potential applied to the fluid using a solid state device positioned within said fluid comprising a set of electrodes consisting of at least an anode, a cathode and a reference electrode, said set of electrodes being encapsulated in a solid electrolyte film, an exterior surface of the film being in contact with said fluid.

2. The method of claim 1 wherein the electrical potential is applied through the anode and is cycled from about −1.4 volts to about 1.4 volts and the current flowing through the fluid in response thereto is monitored at the cathode.

3. A device for monitoring the existence of electrolytic species existing in or generated during the use of a non-electrolytic of weakly electrolytic fluids, the device comprising a set of electrodes consisting of at least an anode, a cathode and a reference electrode encapsulated in a solid electrolyte film, an exterior surface of the film being in contact with said fluid.

4. The device of claim 2 wherein the solid electrolyte film comprises a perfluorosulfonate ionomer film.
